(19) United States
(12) Patent Application Publication
(10) Pub. No.: US 2016/0086417 A1
(43) Pub. Date: Mar. 24, 2016

(54) VENDING MACHINE WITH WIRELESS-ENABLED CURRENCY ACCEPTOR

(71) Applicant: PYRAMID GROUP, INC., MESA, AZ (US)

(72) Inventors: DAVID S. MAYS, MESA, AZ (US); BRIAN WEDDING, SAN TAN VALLEY, AZ (US); CORY A. TODD, MESA, AZ (US); KERRIE L. NOLLETTE, PHOENIX, AZ (US); LEIF J. STROM, GILBERT, AZ (US); TOMISLAV JERAS, GILBERT, AZ (US)

(73) Assignee: PYRAMID GROUP, INC., MESA, AZ (US)

(21) Appl. No.: 14/798,580

(22) Filed: Jul. 14, 2015

Related U.S. Application Data
(60) Provisional application No. 62/054,730, filed on Sep. 24, 2014.

(51) Int. Cl. G07F 9/00; G07F 11/72

(52) U.S. Cl. CPC G07F 9/006; G07F 11/72

(57) ABSTRACT

A vending machine with a security barrier and a wireless-enabled currency acceptor is disclosed. The security barrier comprises a mechanical enclosure that surrounds, and restricts access to, items within the vending machine. The items enclosed in the vending machine inside the security barrier include a product, a currency acceptor, and a currency within the currency acceptor. Mechanical access through the security barrier is provided through a locked access port. The vending machine includes a wireless connectivity device that is coupled to the currency acceptor within the security barrier. The wireless connectivity device provides for password-protected wireless access to the currency acceptor from outside the security barrier. Also disclosed is a method of limiting access to items stored within a vending machine that includes programming the currency acceptor to provide currency acceptor data to the wireless connectivity device. The wireless connectivity device transmits the data wirelessly across the security barrier.

### CROSS REFERENCE TO RELATED APPLICATION

This application claims priority to U.S. Patent Application Ser. No. 62/054,730, filed Sep. 24, 2014, and entitled “Vending Machine with 1 Improved Security”, which is incorporated herein by reference in its entirety.

### BACKGROUND OF THE INVENTION

1. Technical Field

This invention relates to currency acceptors for vending machines and specifically to a currency acceptor with wireless communication capability.

2. State of the Art

Vending machines are automated machines that sell products. A customer inserts payment in the form of currency, coins or electronic payment, and the vending machine automatically dispenses the product, with no human intervention necessary. Vending machines are often used to sell products in areas and places where it is not cost effective to maintain a retail store or an employee to sell the product and conduct the payment transaction. Similarly, gaming machines are vending machines that accept currency in return for dispensing a turn at playing a game. Gaming machines and other vending machines often use a currency acceptor to accept and validate bank note currency from a customer for payment of the items being dispensed. Vending machine owners wish to keep the currency and the product inside the vending machine safe, which is usually accomplished using a lock on the vending machine enclosure. Currently, key access must be provided to those who wish to check, troubleshoot, or update the currency acceptor, as well as those who will be collecting currency or refilling product inventory. Every time an individual with key access opens the vending machine enclosure, there is an opportunity for theft, vandalism, or other mischief to the vending machine and items within the vending machine enclosure, such as products or currency within the currency acceptor. In addition, every time the vending machine enclosure is unlocked, there is the possibility that it will not be properly secured after it is opened. It is desirable to have a system that allows cost effective and secure wireless electronic access to the currency acceptor within the vending machine such that the currency acceptor can be checked, updated, and repaired without requiring physical access to the inside of the vending machine.

### BRIEF DESCRIPTION OF THE DRAWINGS

FIG. 1 shows a front perspective view of a vending machine with a security barrier;

FIG. 2 shows a simplified block diagram of the vending machine with a security barrier of FIG. 1;

FIG. 3 shows a front view of a currency acceptor communicating with a wireless connectivity device, which in turn wirelessly communicates with a mobile computing device;

FIG. 4 shows an exploded view of a wireless connectivity device;

FIG. 5 illustrates a method of limiting access to items stored within a vending machine.

### DETAILED DESCRIPTION OF EMBODIMENTS OF THE INVENTION

As discussed above, disclosed herein are embodiments of a currency acceptor for vending machines, and specifically to a currency acceptor with wireless communication capability.

Disclosed is a vending machine with a security barrier. The security barrier comprises a mechanical enclosure that surrounds and restricts access to items within the vending machine. The items enclosed in the vending machine inside the security barrier include a product, a currency acceptor, and a currency within the currency acceptor. Mechanical access through the security barrier is provided through a locked access port. It is desirable to limit access using the locked access port because whoever obtains access through the locked access port has physical access to all of the items within the security barrier, including the product, the currency acceptor, and the currency within the currency acceptor. Every time the vending machine is accessed, or opened, using the mechanical access port, there is opportunity for theft of items within the vending machine. Disclosed herein is a wireless connectivity device that is coupled to the currency acceptor within the security barrier. The wireless connectivity device provides for password-protected wireless access to the currency acceptor from outside the security barrier for a variety of vending machine maintenance jobs, which can then be performed without physically entering the security barrier. This reduces the opportunity for theft and vandalism of items within the security barrier of the vending machine.

Vending machines, which include automated machines that dispense products, gaming machines that dispense turns at playing a game, or machines that dispense other services in return for money, often include a currency acceptor which accepts currency in payment for the services or products. The currency acceptor is a key component of any vending machine because it accepts payment for the dispensed product or service. Currency acceptors, also called bill acceptors or currency validators, are high failure rate components within a vending machine, requiring frequent service. Currency acceptors require service or repair to determine if the currency acceptor is operating properly; to check whether the currency acceptor is translating each bill into the correct amount of credit; to update the currency accepting data of the currency acceptor; and to perform other repairs or software, firmware, or hardware updates to the currency acceptor. Traditionally, currency acceptor repair or updating is performed by giving a key to the vending machine lock to the currency acceptor service personnel. Unfortunately, this gives the service personnel, and others who may be nearby, physical access to all of the items within the vending machine and the currency acceptor, including products and currency. Too often, thefts of items within the vending machine occur while the currency acceptor service personnel are physically accessing the currency acceptor.

Much of the currency acceptor service and updating is done electronically. For example, currency accepting software within the currency acceptor is required to be updated whenever governments change the appearance or design of currency. Currently, a service person will unlock the vending machine and physically plug a cable extending from a proprietary device into a connector on the currency acceptor. New currency acceptor software is then downloaded to the currency acceptor through the cable, which facilitates the electronic data transfer between the currency acceptor and the proprietary device. It would be advantageous if this electronic data transfer could occur wirelessly so that physical access through the security barrier of the vending machine is not required. The disclosed vending machine with a wireless-enabled currency acceptor provides the capability to download new currency accepting data to the currency acceptor wirelessly. This eliminates the need for the individual updating the software to obtain physical access through the security barrier, but instead allows the currency acceptor to communicate wirelessly across the security barrier within a limited distance. To improve security, the distance the wireless-enabled currency acceptor can communicate across the security barrier is desirably limited, so that physical monitoring of the personal performing the wireless updating can be performed. The disclosed vending machine with wireless-enabled currency acceptor also eliminates the need for the vending machine to be continuously connected to the internet. An internet connection introduces the possibility of hacking and electronic vandalism to the vending machine.

In addition, it is an advantage to be able to verify proper bill acceptor operation in a way that does not require access to the inside of the vending machine. Described herein is a method of using a mobile computing device to communicate wirelessly across the security barrier of the vending machine and retrieve currency acceptor status data from the currency acceptor. In this way, the status of the currency acceptor can be checked without requiring physical access through the security barrier into the inside of the vending machine.

It is also advantageous to allow wireless access to other electronic devices within the vending machine through the currency acceptor For example; liquid crystal displays (LCDs) are in common use on vending machines to display messages. In order to service the LCD or change its message, it is often required that service personnel open the vending machine to plug a cable into the LCD. The described vending machine with a wireless-enabled currency acceptor allows for a way to avoid service personal obtaining physical access through the locked access port. Described herein is a currency acceptor in which a currency acceptor control board is electrically coupled to a microprocessor controller of the vending machine that controls the LCD. Data can be wirelessly supplied to the microprocessor controller and the LCD by wirelessly transmitting the data to the currency acceptor. The currency acceptor conducts the data to the microprocessor controller. This eliminates the need for LCD service personnel to open the vending machine and obtain access to the product, the currency acceptor, and the currency within the vending machine.

The disclosed vending machine with a wireless-enabled currency acceptor, and method of limiting access to items stored within the vending machine, provide a means to access the currency acceptor within a vending machine without providing physical access to the inside of the vending machine. In addition, the disclosed wireless-enabled currency acceptor communicates wirelessly across the vending machine security barrier within a limited distance and without using an internet connection or a cellphone receiver inside the vending machine security barrier. This increases the security of the vending machine and decreases the cost of the wireless access. Placing an internet connection within the security barrier of the vending machine creates an opportunity for hackers around the world to electronically break through the security barrier and access the machine electronically, potentially harming or mis-programming the machine and causing financial loss to the vending machine's owner. Placing a cellular telephone receive inside the security barrier of the vending machine incurs the monthly cost of cellular phone service and also allows access to individuals a great distance away from the vending machine to obtain access, possibly with malicious purposes. The disclosed wireless-enabled currency acceptor allows wireless access across the security barrier within a limited distance of less than about 150 feet. This minimizes physical access through the security barrier, and maintains the ability to monitor individuals wirelessly accessing the currency acceptor within the vending machine. The security of the items within the vending machine is heightened, and the possibility of electronically hacking into the vending machine is reduced.

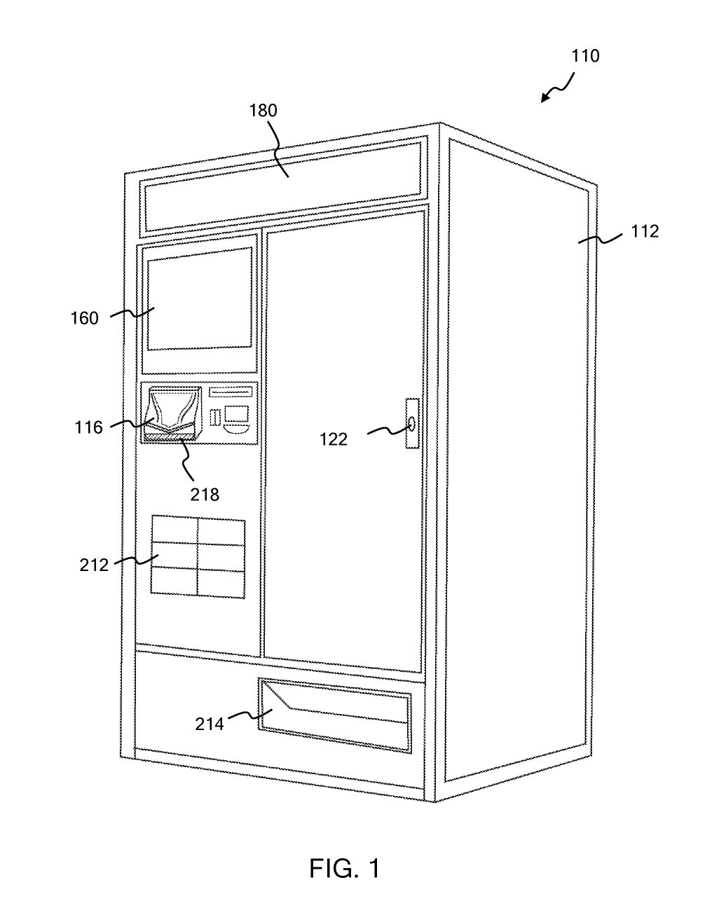

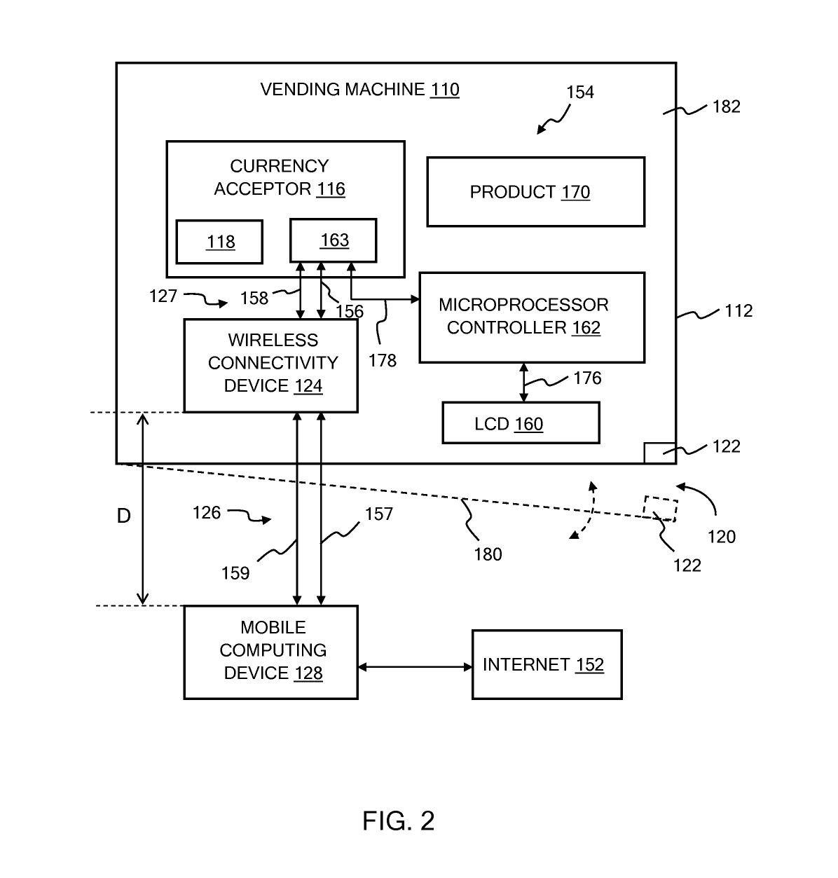

FIG. 1 and FIG. 2 show a vending machine 110 that includes a currency acceptor 116. FIG. 1 shows a front perspective view of vending machine 110. FIG. 2 shows a simplified block diagram of vending machine 110. Vending machine 110 includes a security barrier 112, which in this embodiment is a physical enclosure for the items 154 within the vending machine. Security barrier 112 is box-shaped enclosure in this embodiment, with a hinged front panel 180 secured with a lock 122. Individuals afforded physical access inside security barrier 112 use a key to unlock lock 122, then access items 154 (see FIG. 2) through a locked mechanical access port 120 that is opened when front panel 180 hinges open. As discussed earlier, it is desirable to limit the number of individuals who have key access through locked mechanical access port 120, and to limit the number of times an individual uses locked mechanical access port 120 to access items 154 within the vending machine.

Vending machine 110 includes items 154 inside security barrier 112. In this embodiment, these items 154 include a product 170, the currency acceptor 116, a wireless connectivity device 124 electrically coupled to currency acceptor 116, a currency 118 contained within currency acceptor 116, a vending machine microprocessor controller 162, and a liquid crystal display (LCD) 160. LCD 160 displays data on the outer surface of vending machine 110, as shown in FIG. 1, and is electronically driven by microprocessor controller 162, as shown in FIG. 2. Product 170 is dispensed through dispense port 214 (FIG. 1). A customer inserts currency 118 into currency acceptor 116 through currency slot 218 (see FIG. 1). Currency acceptor 116 credits the customer according to the currency 118 received. The customer chooses which product to receive using product choice buttons 212. Product 170 is then dispensed through dispense port 214. Currency 118 is stored within currency acceptor 116 until retrieved by the vending machine owner.

It is to be understood that FIG. 1 and FIG. 2 show one embodiment of a vending machine 110, but this example is not meant to be limiting. Vending machine 110 can be any type or size of vending machine, gaming machine, or dispensing machine that trades a product or service for currency and uses a currency acceptor to accept payment for the product or service. Security barrier 112 can take any physical form and use locks or other secured mechanical devices to limit physical access to items 154 within vending machine 110. Items 154 within vending machine 110 include currency acceptor 116 and wireless connectivity device 124, and can include many other items in addition to, or instead of product 170, microprocessor controller 162, and LCD 160. Product 170 may be a service or a game, for example, but can also be food, drinks, or other products. Product 170 may be accessed by means other than dispense port 214 and buttons 212, depending on the specific type of vending or gaming machine 110 being used.

Security barrier 112 physically protects and secures items 154 within vending machine 110, which in this embodiment includes currency acceptor 116, currency 118 within currency acceptor 116, and product 170. Wireless connectivity device 124 is electrically coupled to currency acceptor 116. Wireless connectivity device 124 transmits wireless communication 126 (FIG. 2) across security barrier 112. In this embodiment wireless communication 126 is in the form of radio waves. Wireless communication 126 can take many different forms, but in this embodiment, wireless communication 126 is Bluetooth™ communication at a frequency between about 2400 megahertz (MHz) and about 2480 MHz. This is an example only of a form of wireless communication 126 and is not meant to be limiting. Wireless communication 126 can be any form or type of wireless communication including a wireless area network communication, a personal network communication, ZigBee communication, optical communication, or other form of wireless communication.

Wireless communication 126 extends across security barrier 112 between wireless connectivity device 124 and mobile computing device 128 (FIG. 2). Wireless communication 126 extends a limited predetermined distance D. Wireless communication 126 is designed to extend predetermined distance D that is limited in order to limit the distance that mobile computing device 128 can be from vending machine 110 and still communicate wirelessly with wireless connectivity device 124 and currency acceptor 116. In this embodiment, predetermined distance D is less than or equal to about 150 feet, but this is not meant to be limiting. In some embodiments, predetermined distance D is a distance other than 150 feet. Limiting the distance D that wireless communication 126 extends from wireless connectivity device 124 increases the security of vending machine 110. Limiting predetermined distance D requires that mobile computing device 128 be less than a distance D from vending machine 110 in order to communicate with wireless connectivity device 124. This allows monitoring of individuals using mobile computing device 128. Distance D can be chosen and tailored for different applications, depending on how this monitoring is performed. If distance D is allowed to become too large, wireless connectivity device 124 could be hacked by unauthorized devices that are so far away from vending machine 110 that they cannot be detected or controlled.

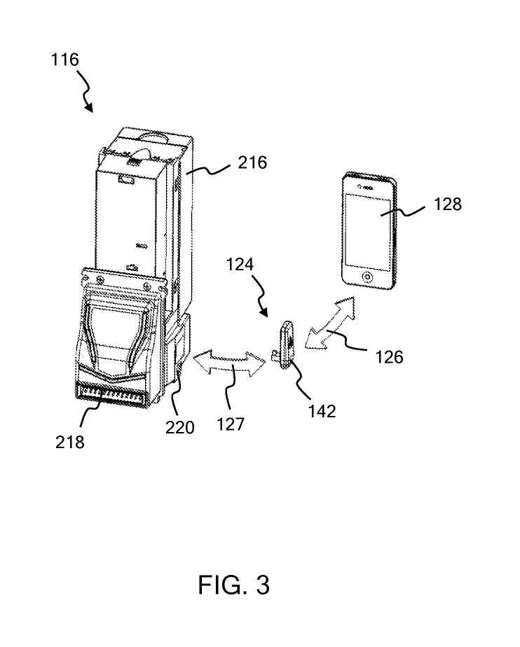

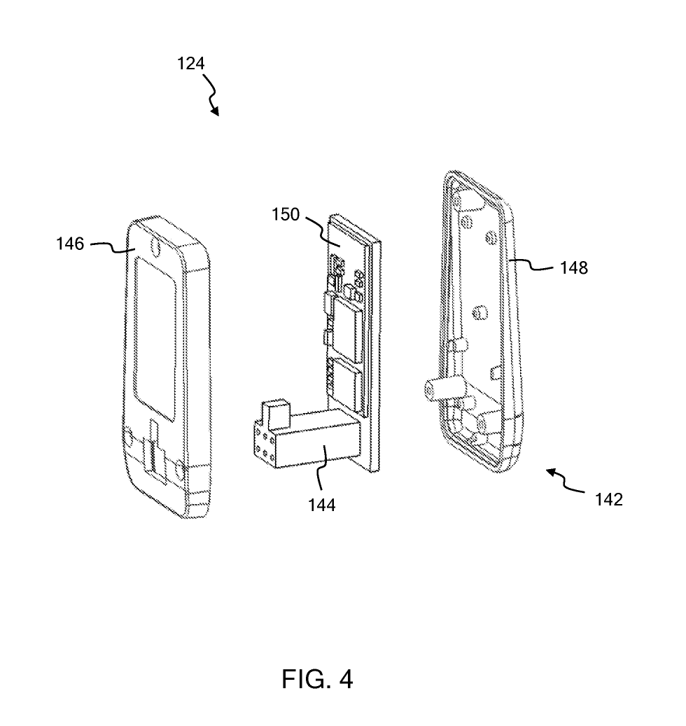

FIG. 3 and FIG. 4 show further details of currency acceptor 116 and wireless connectivity device 124. FIG. 3 shows wireless connectivity device 124, currency acceptor 116, and mobile computing device 128. FIG. 4 shows an exploded view of wireless connectivity device 124.

Referring to FIG. 3, currency acceptor 116 includes a case 216, currency insertion slot 218, and a connection port 220. Connection port 220 (see FIG. 2) is where a cable may be connected to download currency acceptor data and to otherwise electrically access a currency acceptor control board 163 within currency acceptor 116 if no wireless connectivity device 124 is present. In this embodiment, wireless connectivity device 124 is electrically hard wire connected to port 220 such that wired communication 127 occurs between currency acceptor 116 and wireless connectivity device 142.

Wireless connectivity device 124 is both mechanically and electrically coupled to currency acceptor 116 in this embodiment, but this is not meant to be limiting. In the embodiment shown in FIG. 3 and FIG. 4, wireless connectivity device 124 mechanically and electrically couples to currency acceptor 116 using a connector 144 (FIG. 4). In some embodiments, wireless connectivity device 124 is mechanically mounted separate from currency acceptor 116, but still within security boundary 112. In an embodiment where wireless connectivity device 124 is not mechanically coupled to currency acceptor 116, wired communication 127 would take the form of a cable or other wired electrical conduction means electrically connecting wireless connectivity device 124.

Wireless connectivity device 124 includes a housing 142 that include a front housing 146 and a rear housing 148, as shown in FIG. 4. Front housing 146 and rear housing 148 mechanically couple together to enclose a wireless connectivity control board 150. Wireless connectivity control board 150 contains a transmitter/receiver which wirelessly transmits and receives wireless communication 126. Wireless connectivity control board 150 also contains the electronics which convert wired communication 127 into wired communication 126, and vice versa. In this embodiment wireless connectivity control board 150 is a Bluetooth™ circuit board, but this is not meant to be limiting. Wireless connectivity control board 150 also includes connector 144, which in this embodiment mechanically couples wireless connectivity device 124 to currency acceptor 116 by plugging into connection port 220. Connector 144 also electrically couples wireless connectivity device 124 to currency acceptor 116. Connector 144 conducts wired communication 127 between currency acceptor control board 163 of currency acceptor 116, and wireless connectivity device control board 150 of wireless connectivity device 124.

Referring back to FIG. 2, wireless connectivity device 124 wirelessly communicates with mobile computing device 128 using wireless communication 126. Wireless connectivity device 124 is configured to wirelessly communicate information from currency acceptor 116 to mobile computing device 128 once mobile computing device 128 has provided a password or other authentication data to wireless connectivity device 124, and currency acceptor 116 has authenticated the password.

Wireless communication 126 includes wireless password communication channel 159, and wireless data communication channel 157. In this context, a “channel” such as channel 157 or 159, refers to any way known to those skilled in the art to electronically separate different data, such as through the use of different wires or cables, different frequencies, different timing windows, different protocols, different sequencing, or the like. Similarly, wired communication link 127 includes wired password communication channel 158 and wired data communication channel 156. Wireless data communication channel 157 is blocked by wireless connectivity device 124 until mobile computing device 128 presents a password or other authentication data using wireless password communication channel 159. Wireless connectivity device 124 presents the password to currency acceptor control board 163 using wired password communication channel 158. Once currency acceptor control board 163 receives and accepts the password, wireless connectivity device 124 opens wireless data communication channel 157 and sends data received from wired data communication channel 156 from currency acceptor control board 163 to mobile computing device 128 using wireless data communication channel 157, and vice versa. Once mobile computing device 128 is authenticated by currency acceptor control board 163, then data communication between mobile computing device 128 and currency acceptor control board 163 occurs through wireless connectivity device 124. Wireless connectivity device 124 wirelessly communicates with mobile computing device 128 in response to currency acceptor control board 163 of currency acceptor 116 authenticating the password transmitted from mobile computing device 128 across security barrier 112 to wireless connectivity device 124.

Wireless data communication channel 157 can include many types of data communication. Wireless data communication channel 157 can include currency acceptor data being transmitted from currency acceptor 116 to mobile computing device 128. Wireless data communication channel 157 can include data being transmitted from mobile computing device 128 to currency acceptor 116. In some embodiments, wireless data communication channel 157 includes currency acceptor status data. In this embodiment, wireless connectivity device 124 receives currency acceptor status data from currency acceptor 116. Wireless connectivity device 124 transmits the currency acceptor status data across security barrier 112 to mobile computing device 128 in response to currency acceptor 116 authenticating the password from mobile computing device 128. The service personnel using mobile computing device 128 and receiving the currency acceptor status data transmitted across security barrier 112 is able to determine the status of currency acceptor 116 without obtaining physical access through security barrier 112 and having access to items 154 in vending machine 110. This minimizes the number of individuals who have physical access inside vending machine 110, and minimizes the number of opportunities for theft, vandalism, or mischief of items 154, including product 170 and currency 118.

In some embodiments, wireless connectivity device 124 transmits a credit signal from currency acceptor control board 163 of currency acceptor 116 to mobile computing device 128 through wireless connectivity device 124 in response to currency acceptor 116 authenticating the password from mobile computing device 128. The credit signal is, in this embodiment, a part of wireless data communication channel 157. The credit signal will allow service personnel using mobile computing device 128 to determine if currency acceptor 116 is crediting customers the proper amount for each piece of currency 118 submitted, again without giving the service personnel physical access through security barrier 112.

In some embodiments, wireless data communication channel 157 includes currency accepting updates being transmitted from mobile computing device 128 to currency acceptor 116 across security barrier 112 through wireless connectivity device 124. Transmitting currency acceptor updates across security barrier 112 allows service personnel using mobile computing device 128 to download new currency accepting software updates without obtaining physical access through security barrier 112.

Currency acceptor 116 and wireless connectivity device 124 in this embodiment include the capability to update and control LCD 160. LCD 160 is installed in vending machine 110 to provide information and messages to customers of vending machine 110, as shown in FIG. 1 and FIG. 2. LCD 160 is installed in vending machine 110 inside security barrier 112. LCD 160 is controlled and driven by microprocessor controller 162. LCD 160 is electrically coupled to microprocessor controller 162 with interconnection 176. Data flows in two directions between microprocessor controller 162 and LCD 160 using interconnection 176.

Microprocessor controller 162 is electrically coupled to currency acceptor control board 163 with interconnection 178. Data flows in two directions between microprocessor controller 162 and currency acceptor control board 163 using interconnection 178. Having microprocessor controller 162 and LCD 160 electrically coupled to currency acceptor control board 163 of currency acceptor 116 allows microprocessor controller 162 and LCD 160 to be wirelessly accessed through currency acceptor 116 and wireless connectivity device 124. For example, LCD 160 can be programmed or serviced by a service technician using mobile computing device 128. Mobile computing device 128 will access microprocessor controller 162 and LCD 160 by connecting wirelessly across security barrier 112 to wireless connectivity device 124, and then connecting to currency acceptor control board 163, microprocessor control board 162, and LCD 160 through wireless connectivity device 124. This allows LCD 160 to be checked, re-programmed, or serviced without providing physical access to items 154.

In another example embodiment, currency acceptor 116 is programmed to send currency acceptor status data, credit signal data, or other currency acceptor data to microprocessor controller 162, which displays the data on LCD160, in response to commands received from mobile computing device 128 through wireless connectivity device 124. This is advantageous because the currency acceptor data can be obtained by personnel using mobile computing device 128, without giving physical access to items 154 in vending machine 110, and in addition, the personnel using mobile computing device 128 will need to be near LCD 160 to view the information. This keeps personnel wirelessly accessing currency acceptor 116 physically locked out of vending machine 110, able to obtain currency acceptor data from currency acceptor 116 by wirelessly accessing currency acceptor 116 across security barrier 112, while still requiring the service personnel to be close to vending machine 110 so that the service personnel can be monitored and their identification tracked.

In the embodiment of vending machine 110 shown in FIG. 1 and FIG. 2, none of the components within vending machine 110 are capable of having an internet connection without the aid of a device external to security barrier 112. This increases the security of the data and components within vending machine 110 because if a component of vending machine 110 inside security barrier 112 has an internet connection, it is possible for a hacker anywhere in the world to hack into vending machine 110 and re-program, disable, or otherwise maliciously control currency acceptor 116, microprocessor controller 162, or LCD 160. In the embodiment shown in FIG. 2, mobile computing device 128 is coupled to internet 152. If it is desired to download new software or otherwise send data to currency acceptor 116 or LCD 160 from internet 152, this data is retrieved from internet 152 by mobile computing device 128, and then wirelessly transmitted to currency acceptor 116 through wireless connectivity device 124. In this way, the only connection between currency acceptor 116 and internet 152 is through wireless connectivity device 124, and then from wireless connectivity device 124 through mobile computing device 128 to internet 152. This minimizes the possibility of hackers hacking into currency acceptor 116 through an internet connection.

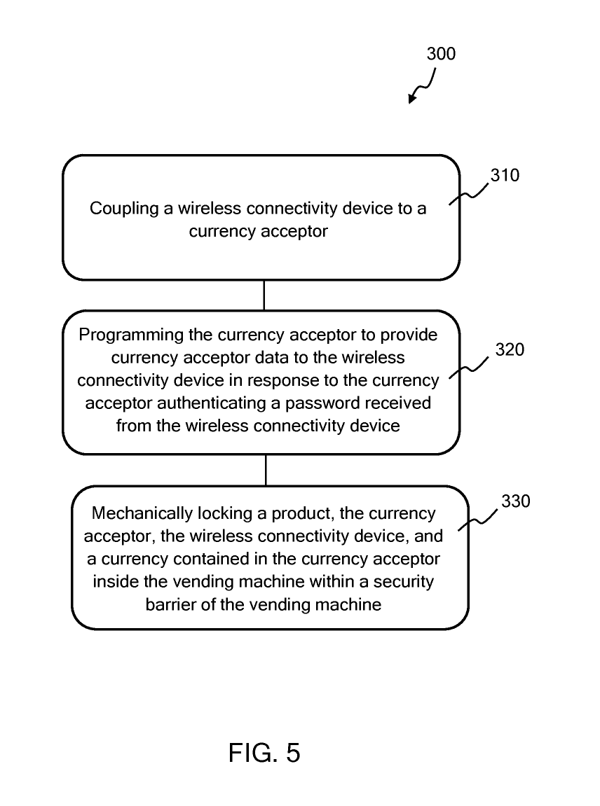

FIG. 5 illustrates a method 300 of limiting access to items stored within a vending machine. Method 300 of limiting access to items stored within a vending machine includes act 310 of coupling a wireless connectivity device to a currency acceptor. Method 300 also includes act 320 of programming the currency acceptor to provide currency acceptor data to the wireless connectivity device in response to the currency acceptor authenticating a password received from the wireless connectivity device. And method 300 of limiting access to items stored within a vending machine includes act 330 of mechanically locking a product, the currency acceptor, the wireless connectivity device, and a currency contained in the currency acceptor inside the vending machine within a security barrier of the vending machine.

Method 300 can include many other acts. In some embodiments, method 300 includes configuring the wireless connectivity device to wirelessly communicate with a mobile computing device positioned outside the security barrier in response to the currency acceptor authenticating the password. In some embodiments, method 300 includes programming the wireless connectivity device to wirelessly transmit a currency acceptor status data across the security barrier to the mobile computing device. In some embodiments, method 300 includes programming the wireless connectivity device to wirelessly transmit a credit signal of the currency acceptor across the security barrier to the mobile computing device. In some embodiments, method 300 includes programming the currency acceptor to process currency accepting updates received from the mobile computing device through the wireless connectivity device.

In some embodiments, method 300 includes limiting the distance that the wireless connectivity device can communicate with the mobile computing device across the security barrier to less than about 150 feet. In some embodiments, method 300 includes mechanically coupling the wireless connectivity device to the currency acceptor. In some embodiments, method 300 includes coupling the currency acceptor to the internet through the mobile computing device.

In some embodiments, method 300 includes electrically coupling the wireless connectivity device to a currency acceptor control board of the currency acceptor and electrically coupling the currency acceptor control board to a microprocessor controller of the vending machine. In some embodiments, method 300 includes wirelessly transmitting liquid crystal display data from the mobile computing device to the microprocessor controller through the wireless connectivity device, and the currency acceptor control board. In some embodiments, method 300 includes using the microprocessor controller to display the liquid crystal display data on the liquid crystal display. In some embodiments, the liquid crystal display data comprises a credit signal of the currency acceptor. In some embodiments of method 300, the liquid crystal display data comprises a currency acceptor status reading of the currency acceptor. Method 300 can include many other elements or acts.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A method of limiting access to items stored within a vending machine, the method comprising:
coupling a wireless connectivity device to a currency acceptor;
programming the currency acceptor to provide currency acceptor data to the wireless connectivity device in response to the currency acceptor authenticating a password received from the wireless connectivity device;
and
mechanically locking a product, the currency acceptor, the wireless connectivity device, and a currency contained in the currency acceptor inside the vending machine within a security barrier of the vending machine.

2. The method of claim 1, further comprising configuring the wireless connectivity device to wirelessly communicate with a mobile computing device positioned outside the security barrier in response to the currency acceptor authenticating the password.

3. The method of claim 2, further comprising programming the wireless connectivity device to wirelessly transmit a currency acceptor status data across the security barrier to the mobile computing device.

4. The method of claim 2, further comprising programming the wireless connectivity device to wirelessly transmit a credit signal of the currency acceptor across the security barrier to the mobile computing device.

5. The method of claim 2, further comprising programming the currency acceptor to process currency accepting updates received from the mobile computing device through the wireless connectivity device.

6. The method of claim 2, further comprising limiting the distance that the wireless connectivity device can communicate with the mobile computing device across the security barrier to less than about 150 feet.

7. The method of claim 2, further comprising:
electrically coupling the wireless connectivity device to a currency acceptor control board of the currency acceptor;
electrically coupling the currency acceptor control board to a microprocessor controller of the vending machine;
wirelessly transmitting liquid crystal display data from the mobile computing device to the microprocessor controller through the wireless connectivity device, and the currency acceptor control board;
and
using the microprocessor controller to display the liquid crystal display data on the liquid crystal display.

8. The method of claim 7, wherein the liquid crystal display data comprises a credit signal of the currency acceptor.

9. The method of claim 7, wherein the liquid crystal display data comprises a currency acceptor status reading of the currency acceptor.

10. The method of claim 1, further comprising mechanically coupling the wireless connectivity device to the currency acceptor.

11. The method of claim 1, further comprising coupling the currency acceptor to the internet through the mobile computing device.

12. A vending machine with a security barrier, wherein a vending machine product, a currency acceptor, and a currency within the currency acceptor are enclosed inside the security barrier, and wherein mechanical access through the security barrier is allowed through a locked mechanical access port, the vending machine comprising:
a wireless connectivity device installed within the security barrier, wherein the wireless connectivity device is electrically coupled to the currency acceptor, and wherein the wireless connectivity device transmits radio waves across the security barrier.

13. The vending machine of claim 12, wherein the wireless connectivity device transmits radio waves a distance across the security barrier, the distance being less than about 150 feet.

14. The vending machine of claim 13, wherein the wireless connectivity device wirelessly communicates with a mobile computing device in response to the currency acceptor authenticating a password transmitted from the mobile computing device across the security barrier to the wireless connectivity device.

15. The vending machine of claim 14, wherein the wireless connectivity device wirelessly communicates with the mobile computing device at a frequency between about 2400 megahertz to about 2480 megahertz.

16. The vending machine of claim 14, wherein the wireless connectivity device receives currency acceptor status data from the currency acceptor, and wherein the wireless connectivity device transmits the currency acceptor status data across the security barrier to the mobile computing device in response to the currency acceptor authenticating the password.

17. The vending machine of claim 14, wherein the wireless connectivity device transmits a credit signal from the currency acceptor to the mobile computing device in response to the currency acceptor authenticating the password.

18. The vending machine of claim 14, further comprising:
a liquid crystal display installed in the vending machine inside the security barrier;
a microprocessor controller electrically coupled to the liquid crystal display, wherein the microprocessor controller drives the liquid crystal display;
a currency acceptor control board electrically coupled to the microprocessor control board, wherein the wireless connectivity device conducts liquid crystal display data to the microprocessor controller from the mobile computing device through the wireless connectivity device and the currency acceptor.

19. The vending machine of claim 12, wherein the only connection between the currency acceptor and the internet is through the wireless connectivity device and the mobile computing device.

20. The vending machine of claim 12, wherein none of the components inside the vending machine security barrier are connected to the internet.
